(19) United States
(12) Patent Application Publication
(10) Pub. No.: US 2006/0085301 A1
(43) Pub. Date: Apr. 20, 2006

(54) System and method of cost distribution and invoice management for products having time-based benefits

(76) Inventor: James Leahy, Stamford, CT (US)

Correspondence Address: EDWARDS & ANGELL, LLP, P.O. BOX 55874, BOSTON, MA, 02205, US

(21) Appl. No.: 11/219,189

(22) Filed: Sep. 2, 2005

Related U.S. Application Data
(60) Provisional application No. 60/607,322, filed on Sep. 3, 2004.

(51) Int. Cl. G07F 19/00; H04M 15/00

(52) U.S. Cl. 705/30; 705/34

(57) ABSTRACT

The invention provides a method, system and machine readable program for managing cost distribution. The method, system and machine readable program are each configured to receive information relating to the total cost of a product and generate a multiple cost structure for the product by generating an acquisition cost of the product; and generating at least one operating cost of the product. Generating a cost structure can include calculating at least one of the acquisition cost and operating cost based on a preset formula. Moreover, the cost structure generating step can additionally or alternatively include generating at least one of the acquisition cost and operating cost by manually inputting them through a graphical user interface. The product can be an energy saving device such as a hybrid vehicle, a fuel cell powered device, a light bulb and an energy control system.

### CROSS-REFERENCE TO RELATED APPLICATIONS

This patent application claims priority to Provisional Patent Application Ser. No. 60/607,322, filed Sep. 3, 2004, the entirety of which is incorporated by reference herein.

### BACKGROUND OF THE INVENTION

1. Field of the Invention

The subject invention relates to accounting systems and methods, and more particularly, to a system and method for cost distribution and invoice management and presentment for products having time-based benefits.

2. Background of the Related Art

The world is facing energy crises. Oil and electric prices are at their highest point in history and energy costs are becoming a significant concern for many.

We are all aware that energy efficient products exist, but often balk at the price tag. Energy efficient products save money over their lifetime (lower lifecycle cost), but often are associated with higher acquisition costs and then lower energy costs after acquisition.

At many companies, government agencies and municipalities, a different department is responsible for the acquisition cost than the energy costs. Typically a purchasing department focuses on the acquisition cost (and often are paid bonus based upon “save”) and an energy or facilities department is responsible for the electric bill.

An additional problem is that the acquisition cost hits the income statement immediately for non-capitalized goods, and the energy save may take years to reach a break-even point.

The historical solution to this problem was to attempt to negotiate with a purchasing department and convince them to approach senior management for a budget increase and explain that it is in the best interest of the company because of the subsequent reduction in energy costs. For longer life items, leasing was also considered. This approach works sometimes, but it is a long drawn out process, often requiring multiple levels of approval and, a bigger problem in some companies, financial statement disclosure of the lease liability.

Clearly, there is a need in the art for a system and method that compensates for the aforementioned budgetary concerns and makes the purchase of energy efficient products more attractive.

### SUMMARY OF THE INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof, as well as from the appended drawings.

To achieve these and other advantages and in accordance with the purpose of the invention, as embodied herein and broadly described, the invention includes a method for managing cost distribution. The method includes the steps of receiving information relating to the total cost of a product, such as a sale cost, and generating a multiple cost structure for the product. The cost structure is generated by generating an acquisition cost of the product; and generating at least one operating cost of the product.

In accordance with a further aspect of the invention, the cost structure generating step includes calculating at least one of the acquisition cost and operating cost based on a preset formula. Moreover, the cost structure generating step can additionally or alternatively include generating at least one of the acquisition cost and operating cost by manually inputting them through a graphical user interface.

In accordance with a further aspect, the method can further include the steps of generating a first invoice relating to the acquisition cost of the product and forwarding the invoice to a department of a customer responsible for acquisition costs, such as a purchasing department. Moreover, the method can include the steps of generating a second invoice relating to the at least one operating cost of the product and forwarding the second invoice to a department of a customer responsible for operating costs, such as a facilities department. The second invoice can be generated later than the first invoice, and the operating cost can be calculated based on a theoretical cost savings associated with the product. The method can further include the step of saving data relating to at least one of the acquisition cost and operating cost of a customer in a customer database.

In accordance with another aspect, a machine readable program containing instructions for controlling a cost distribution system is provided. The program includes means for receiving information relating to the total cost of a product and means for generating a multiple cost structure for the product as described herein.

In accordance with a further aspect, the machine readable program can further comprise various means for generating invoices as described herein and forwarding such invoices to one or more departments of a customer. It is recognized that, while different departments can be responsible for acquisition and operating costs, in certain instances a single department could be responsible for both costs. These invoices can be generated at different points in time, and information can be stored in a database by the machine readable program.

In accordance with still another aspect, the invention provides a system for controlling cost distribution system, comprising a database for receiving information relating to the total cost of a product, and a processor operably coupled with the database, the processor being adapted and configured to generate a multiple cost structure for the product as described herein.

In accordance with the invention, the database can be a customer database that is adapted and configured to permit the customer to access the data. The system can further include an interface, such as a local or remote keyboard (such as a PC, cell phone or personal digital assistant) or graphical user interface for permitting a customer to order products based on the acquisition cost and operating cost. The product can be one or more of a variety of energy saving devices, such as hybrid vehicles, fuel cell powered devices, and a lighting devices, such as an energy efficient light bulb.

The accompanying drawings, which are incorporated in and constitute part of this specification, are included to illustrate and provide a further understanding of the method and system of the invention. Together with the description, the drawings serve to explain the principles of the invention.

### BRIEF DESCRIPTION OF THE DRAWINGS

FIG. 1 is a schematic representation of an exemplary system made in accordance with the invention.

FIG. 2 is a flowchart representing an exemplary method carried out in accordance with the present invention.

### ENABLING DESCRIPTION OF THE PREFERRED EMBODIMENTS

The subject invention is directed to a new and useful method, machine readable program and system that solves the problems discussed above. In particular, the subject invention is directed to a system, method and machine readable program for distributing the total purchase cost of a product as separate amounts in multiple invoices. The present system and method is especially useful for products that have time-based or future cost reduction characteristics, such as energy efficient products that have a higher purchase price but reduce operating expenses over time in comparison to products in the same class that are less energy efficient.

The subject disclosure, as detailed in the accompanying pages, is directed to a new and useful system and method which utilizes computers and can utilize a distributed computing network, as well as the world wide web, intranet or Internet, to facilitate formulation and management of an automated system and method for rationing the total purchase cost of a product into multiple invoices based on customer preference.

Those skilled in the art will also readily appreciate that a system in accordance with the present disclosure may include the various computer and network related software and hardware typically used in a distributed computing network, that is, programs, operating systems, memory storage devices, input/output devices, data processors, servers with links to data communication systems, wireless or otherwise, such as those which take the form of a local or wide area network, and a plurality of data transceiving terminals within the network, such as personal computers. Those skilled in the art will further appreciate that, so long as its users are provided local and remote access to a system in accordance with the present disclosure, the precise type of network and associated hardware are not vital to its full implementation.

Preferably, the graphical user interfaces (GUIs) used by the present system incorporate user-friendly features and fit seamlessly with other operating system interfaces, that is, in a framed form having borders, multiple folders, toolbars with pull-down menus, embedded links to other screens and various other selectable features associated with animated graphical representations of depressible buttons. These features can be selected (i.e., “clicked on”) by the user via connected mouse, keyboard, voice command or other commonly used tool for indicating a preference in a computerized graphical interface.

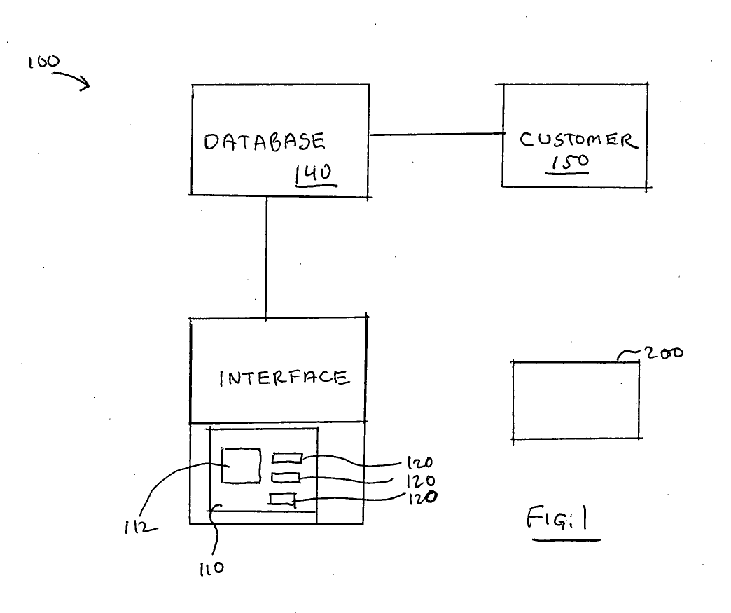

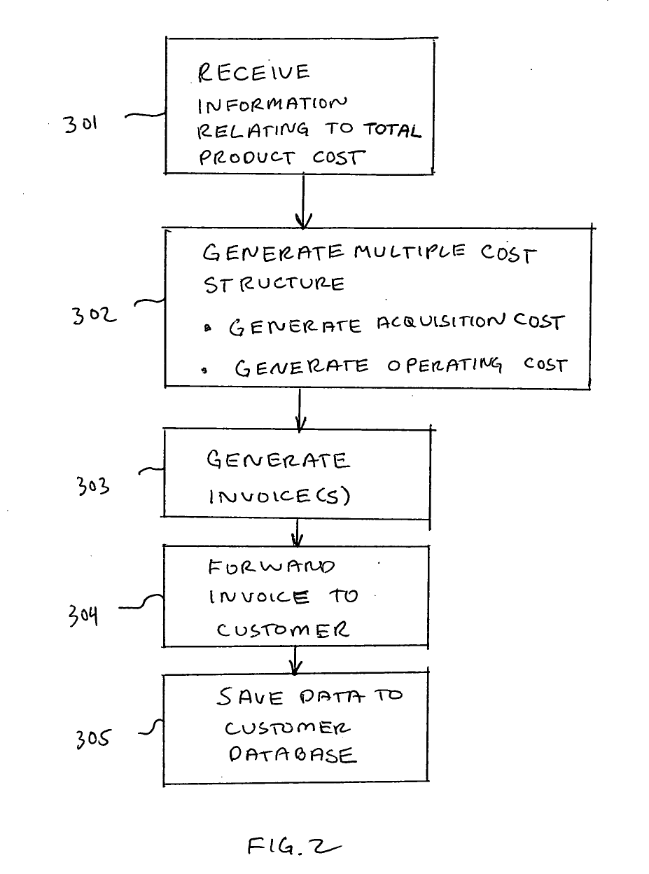

In accordance with the present disclosure and as depicted in FIGS. 1 and 2, data is supplied to the system 100 regarding the total cost of the product 200 in step 301. The system 100 then displays a menu 112 displayed on an interface, such as graphical user interface 110 containing options for generating a multiple cost structure at step 302. These options can include preset formulas for determining a first invoice price and following invoice prices based on percentages of the total cost and the amount of invoices desired, or the number of invoices and corresponding prices can be manually set by either a user or customer. Preferably, the options screen displayed on interface 110 includes various data entry fields 120 for entering the desired variables and invoice descriptions, as well as the addresses and product description to be included in each invoice. The present invention can also generate invoices at step 303 for facsimile or e-mail transmittal at step 304, among other methods, and the timing of the invoice generation can be set so that the invoices are not created all at once. Once all of the options are inputted, the system saves the data corresponding to each customer 150 in a database in step 305, such as customer database 140, and generates invoices according to the configured cost structure.

For example, in the case of an energy efficient product, the total or acquisition cost can be divided into two or more components that can be separated into one or more invoices by a system and method in accordance with the present invention. The physical product can be pitched to the department that handles purchases at an attractive lowered price, such as a price that includes cost-savings over the purchase of a less-efficient standard product. However, the final sale would be contingent on the sale of what is referred to herein as an “Energy Save Component.” The cost of this component can also be negotiated with the department responsible for energy payments, and may be based on the theoretical cost savings associated with the particular product. The present invention can include such theoretical values as part of the formulas used in the aforementioned options menu. The present invention can also create a plurality of invoices. Thus, for example, a third invoice can be created to recoup rebates offered by the government for the purchase of energy efficient products. The invoices can be sent per item sold, or in aggregate sales by day, week, month, quarter, etc.

The present invention is designed to automate this process by receiving the data regarding the agreed upon cost structure, and presenting invoices configured accordingly. The data can be saved in a database associated with the present invention such that the customer can log on or otherwise gain access to the system and order products according to agreed upon cost structures for that particular customer.

For example, energy efficient light bulbs generally cost more than less efficient or standard light bulbs. However, energy efficient light bulbs are more cost-effective, in that they will draw less energy than standard light bulbs and save money over time in energy costs. Thus, the purchase price of a standard bulb plus its associated energy costs over time are actually greater than the purchase price of an energy efficient light bulb plus its energy costs over time.

If, for example, the sale price of a standard light bulb is $3.00 and the sale price of an energy efficient light bulb is $6.00, but yields energy savings of $8.00 over its life, the system and method of the present invention can be configured to provide an exemplary cost structure that makes purchasing the energy efficient bulbs compatible with purchasing department budgetary concerns. The cost structure can be configured so that the energy efficient bulbs are billed for $2.50 each to the purchasing department in a first invoice, thus providing savings over the standard bulb. The energy saving component, which can be billed for a portion of the savings, such as $5.00, can be included on a second invoice and billed to the facilities department or department otherwise responsible for energy payments. A third invoice can be printed with the total purchase price on it for purposes of obtaining any available rebates.

In summary, the purchasing department can maintain its budget while buying better, more energy efficient products for less than the price of less energy efficient products, the facilities department spends less of its budget on energy costs for these products, and the seller/distributor makes an additional $1.50 profit on each unit, and the client saves $3.50 in combined product and energy costs.

Another example is hybrid cars and cars using other alternative fuels, such as propane, which are usually higher priced than comparable automobiles. The acquisition price of these cars can be reduced, and then the purchaser billed a portion of the purchase price as energy savings costs after purchase (that will be offset by reduced gasoline costs). This portion of the price can be spread out in periodic payments over time. Moreover, fuel cell powered devices are also suitable for pricing and sale in accordance with the present invention.

The method of the present invention, which is illustrated in FIG. 2 and includes, for example, the steps of receiving client data or information including number of separate invoices and product price to be billed in each separate invoice for a particular product, receiving an order for that product from the client, presenting each separate invoice to the client based on the order received and client data or information, may be automated by computer or otherwise.

Alternatively, one or more steps pursuant to the method of the present invention can be carried out manually, which advantageously permits the method of the present invention to be utilized in situations where it is not possible to change, upgrade or otherwise configure the existing system to employ the novel features of the system of the present invention, among other things. For example, in the exemplary embodiment described above, a first invoice can be created for energy efficient light bulbs at $2.50 each while the step of creating the second invoice for $5.00 can involve the manual creation of another invoice, rather than it being automatically generated.

The exemplary embodiments described above should not be considered as limiting of the system and method of the present invention in any way. Accordingly, the present invention embraces alternatives, modifications and variations of the present invention as fall within the spirit of the present disclosure as described herein.

What is claimed is:

1. A method for managing cost distribution, comprising the steps of:
a) receiving information relating to the total cost of a product; and
b) generating a multiple cost structure for the product on a computer by:
i) generating an acquisition cost of the product; and
ii) generating at least one operating cost of the product.

2. The method of claim 1, wherein the cost structure generating step includes calculating at least one of the acquisition cost and operating cost based on a preset formula.

3. The method of claim 1, wherein the cost structure generating step includes generating at least one of the acquisition cost and operating cost by manually inputting them through a graphical user interface.

4. The method of claim 1, further including the steps of:
a) generating a first invoice relating to the acquisition cost of the product; and
b) forwarding the invoice to a department of a customer responsible for acquisition costs.

5. The method of claim 4, further including the steps of:
a) generating a second invoice relating to the at least one operating cost of the product; and
b) forwarding the second invoice to a department of a customer responsible for operating costs.

6. The method of claim 5, wherein the second invoice is generated later than the first invoice.

7. The method of claim 1, wherein the operating cost is calculated based on a theoretical cost savings associated with the product.

8. The method of claim 1, further including the step of saving data relating to at least one of the acquisition cost and operating cost of a customer in a customer database.

9. A machine readable program containing instructions for controlling a cost distribution system, wherein the program comprises:
a) means for receiving information relating to the total cost of a product; and
b) means for generating a multiple cost structure for the product including:
i) means for generating an acquisition cost of the product; and
ii) means for generating at least one operating cost of the product.

10. The machine readable program of claim 9, wherein the multiple cost structure generating means includes means for calculating at least one of the acquisition cost and operating cost based on a preset formula.

11. The machine readable program of claim 9, wherein the multiple cost structure generating means includes means for permitting manual input of at least one of the acquisition cost and operating cost through a graphical user interface.

12. The machine readable program of claim 9, further comprising:
a) means for generating a first invoice relating to the acquisition cost of the product; and
b) means for forwarding the invoice to a department of a customer responsible for acquisition costs.

13. The machine readable program of claim 12, further comprising:
a) means for generating a second invoice relating to the at least one operating cost of the product; and
b) means for forwarding the second invoice to a department of a customer responsible for operating costs.

14. The machine readable program of claim 13, wherein the second invoice is generated later than the first invoice.

15. The machine readable program of claim 9, wherein the operating cost is calculated based on a theoretical cost savings associated with the product.

16. The machine readable program of claim 9, further including the step of saving data relating to at least one of the acquisition cost and operating cost of a customer in a customer database.

17. A system for controlling cost distribution system, comprising:
a) a database for receiving information relating to the total cost of a product; and
b) a processor operably coupled with the database, the processor adapted and configured to generate a multiple cost structure for the product, wherein the processor is configured to:
i) generate an acquisition cost of the product; and
ii) generate at least one operating cost of the product.

18. The system of claim 17, wherein the database is a customer database adapted and configured to permit the customer to access data relating to the cost structure.

19. The system of claim 17, further including an interface for permitting a customer to order products based on the acquisition cost and operating cost.

20. The system of claim 17, wherein the product is an energy saving device chosen from the group consisting of a hybrid vehicle, a fuel cell powered device, a light bulb and an energy control system.
